(19) United States
(12) Patent Application Publication
(10) Pub. No.: US 2026/0004130 A1
(43) Pub. Date: Jan. 1, 2026

(54) TRANSFORMER SINGULAR SYNTHESIZED INFERENCE

(71) Applicant: Octavio Silva, Yorba Linda, CA (US)

(72) Inventor: Octavio Silva, Yorba Linda, CA (US)

(21) Appl. No.: 19/253,870

(22) Filed: Jun. 29, 2025

Related U.S. Application Data
(60) Provisional application No. 63/666,180, filed on Jun. 30, 2024.

(51) Int. Cl. G06N 3/08; G06N 3/0455; G06V 10/77; G06V 10/82

(52) U.S. Cl. CPC G06N 3/08; G06N 3/0455; G06V 10/7715; G06V 10/82

(57) ABSTRACT

The patent described herein refers to an artificial intelligence Transformer algorithm, used with processing mechanisms in the data input blocks that allow inference probabilities near 1. The Transformer algorithm belongs to a class of trainable Artificial Intelligence algorithms with autoencoder functions and attention mechanisms for several classes of inference problems. Certain datasets that appear to have a high degree of randomness can be manipulated to make predictions or classification with near certainty. In many cases, classification can be performed with 100% accuracy, a singular inference process. These datasets cover many practical problems and theoretical cases.

### BACKGROUND

Transformer based algorithms were proposed in Attention Is All You Need (Aug. 3, 2017) as a novel inference machine learning model that could outperform current models such as CNN models and generative models. Since then these models have been applied to a wide variety of problems such as protein synthesis, graph m1 algorithms, time series prediction such stock prediction, and computer vision.

### CROSS REFERENCE TO RELATED APPLICATIONS

This is a non-provisional patent submittal, corresponding to provisional patent application No. 63/666,180, Transformer Singular Synthesized Inference, submitted on Jun. 30, 2024.

### DESCRIPTION OF DRAWINGS

FIG. 1 depicts the architecture of the Transformer Autoencoder.

FIG. 2 depicts the prediction of future values by direct floating point data input without any embedding.

FIG. 3 depicts a paradigm to classify centroids with an accurate of 100%.

FIG. 4 depicts a four-centroid classification paradigm with a three-class centroid performance.

FIG. 5A depicts a time series input to the model for prediction of future values.

FIG. 5B depicts the predicted time series from the time series in FIG. 5A.

FIG. 6 depicts an anomaly detection paradigm.

FIG. 7 depicts a computer vision problem to determine the performance of modulation centroids.

FIG. 8 depicts a computer vision problem to determine performance failure of modulation centroids.

FIG. 9 depicts class 0 of synthetic functions to determine certain patterns in a time series.

FIG. 10 depicts class 1 of synthetic functions to determine certain patterns in a time series.

FIG. 11 depicts class 2 of synthetic functions to determine certain patterns in a time series.

FIG. 12 depicts an instance 0 of two square pulses for pattern detection.

FIG. 13 depicts an instance 1 of two square pulses for pattern detection.

FIG. 14 depicts an instance 2 of two square pulses for pattern detection.

FIG. 15 depicts class 0 of synthetic functions to determine certain patterns in a time series.

FIG. 16 depicts class 1 of synthetic functions to determine certain patterns in a time series.

FIG. 17 depicts class 2 of synthetic functions to determine certain patterns in a time series.

FIG. 18 depicts class 0 of synthetic functions to determine certain patterns in a time series.

FIG. 19 depicts class 1 of synthetic functions to determine certain patterns in a time series.

FIG. 20 depicts class 2 of synthetic functions to determine certain patterns in a time series.

FIG. 21 depicts a synthetic function from a stochastic dataset to train anomalies.

FIG. 22 depicts a synthetic function from a stochastic dataset to train anomalies.

FIG. 23A depicts the first half of the method to train a Transformer model.

FIG. 23B depicts the second half of the method to train a Transformer model.

FIG. 24 depicts the method to use a trained Transformer model for inference.

### BRIEF SUMMARY OF THE INVENTION

The patent described herein refers to an artificial intelligence transformer algorithm, used with interface processing mechanisms that allow inference probabilities near 1. The Transformer algorithm belongs to a class of trainable Artificial Intelligence algorithms with autoencoder functions and attention mechanisms for several classes of inference problems. Certain data sets that appear to have a high degree of randomness can be manipulated to make predictions or classification with nearly 100% of certainty. These datasets cover a whole gamut of natural processes that model physical phenomena accurately. One such example, is the transmission of information over memoryless Gaussian channels. Applications of these include information transmitted through satellite networks that are corrupted by noise. Another example is the transmission of information in fiber optics networks. Both of these media encompass receiving systems comprised of semiconductor devices that introduce thermal noise that can be modeled as a Gaussian process. The invention, algorithms, and methods described herein accurately model the behavior of these systems. These algorithms can recognize patterns in the waveforms that are used to transmit information in the form of time series. In addition, they can model classification problems such as modulation performance classes or prediction problems, dealing with the future values of certain parameters such as received power levels or signal to noise ratio.

### DETAILED DESCRIPTION OF THE PATENT

The algorithm and methodology described in here pertains to n dimensional datasets belonging [symbol] or [symbol] . The dataset can be comprised of a time series, an m1×m2 array whose statistical properties can be viewed as a general stochastic process.

The algorithmic inference mechanism itself is comprised of a computational algorithm mathematical structure embodied in a computer program, the computer program code comprising computer executable instructions hosted in a non-transitory computer-usable medium.

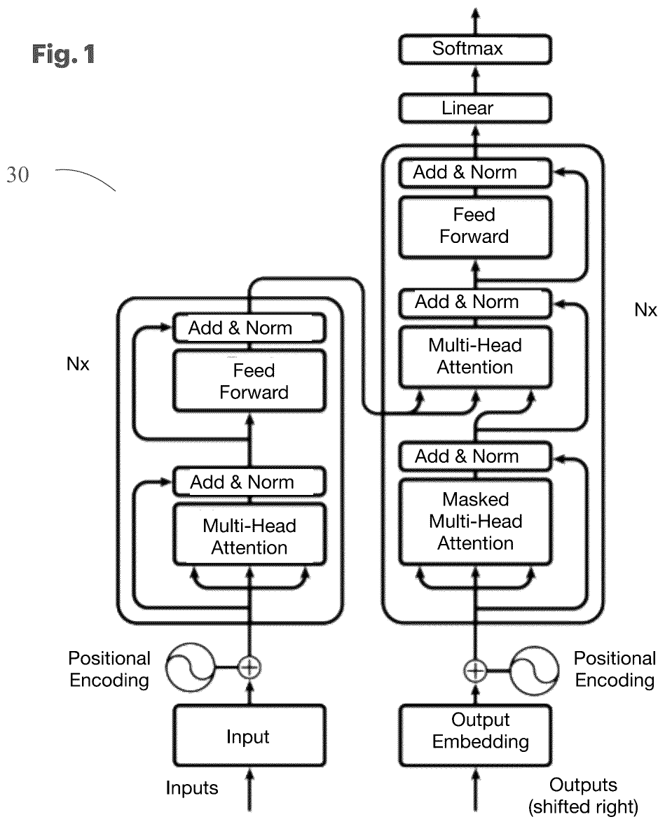

The transformer models are based on the algorithm described in Attention Is All You Need of which a representation is available from TensorFlow.org. Importantly, as a necessary adjunct component, is processing of raw data in such a way that inference can performed with a probability close to 1.0, inherently creating a distinct advantage and a radically different method to feed data to the algorithm to train a model. The general architecture of the Transformer Autoencoder is shown in FIG. 1.

There are other Transformer-like architectures that have been proposed Some of these use variants of the Attention mechanism. An instantiation is described in iTransformer: Inverted Transformers are Effective for Time Series Forecasting by Young Lou, et al, 10 Oct. 2023. The Bidirectional Encoder Representations from Transformers is also sufficiently effective to produce similar inference. Lal, et al, describe in patent application No. 20240403428 an LLM-based AI model to detect cyber threats which lacks the processing of data in input to the Transformer model to allow detection of all types of time series variations without having to train for groups of data series. Typically, all time series should be translated to the same value and normalized within a small range in [0, 1] to account for all possible time series variations. Without this, weight training would only predict on sub-group of those time series.

The Transformer Autoencoder was initially developed for NLP tasks in which case representations of words are input to an embedding component and in turn fed to the encoder. In such a scheme, the input to the encoder is a set of integers which is not very useful for model training using time series that belong to the set of real numbers.

The Transformer can be characterized by the following equations;
Each Attention mechanism has Query, Key, Value inputs of the form;

$$Attention ( Q , K , V ) = Softmax ( \frac{Q {K}^{T}}{\sqrt{{d}_{k}}} ) V . \qquad ( 1 )$$

The Multihead operation has the general form;

$$MultiHead ( Q , K , V ) - Concat ( {head}_{1} {head}_{2} … {head}_{h} ) {W}^{O} ; \qquad ( 2 )$$

$$where {head}_{i} = Attention ( Q {W}_{i}^{Q} , K {W}_{i}^{K} , V {W}_{i}^{V} ) . \qquad ( 3 )$$

Where the projections are parameter matrices;

$${W}_{i}^{Q} ∈ {ℝ}^{{d}_{model} \times {d}_{k}} , {W}_{i}^{K} ∈ {ℝ}^{{d}_{model} \times {d}_{k}} , {W}_{i}^{V} ∈ {ℝ}^{{d}_{model} \times {d}_{v}} ; \qquad ( 4 )$$

$${W}^{O} ∈ {ℝ}^{{hd}_{d} \times {d}_{model}} . \qquad ( 5 )$$

The Feed Forward Neural Network defined by the input product space χ1×χ2 has the form;

$$F F N = max ( 0 , {xW}_{1} + {b}_{1} ) {W}_{2} + {b}_{2} . \qquad ( 6 )$$

The NLP embedding input is replaced by another embedding that maps the processed time series of any shape to a direct input to the encoder. The processing and mapping is the subject of this invention. The unique aspects are related to exact inference for several classes of raw data sets.

The training and inference processes are different than those of NLP. NLP datasets, for example, can be subsets of 10,000 words and data can be encoded as hot vectors. There are other approaches to this paradigm but the approach for datasets that belong to [symbol] is a radical departure.

### Comparison to Original Transformer

The Attention mechanism is key to perform faithful predictions of the input data. The Query, Key, and Value in the encoder which are formed by a linear transformation of the same input acts as a similarity discriminator to search for the most likely output. The padding used for asymmetrical data for the input is detrimental to sequences used for classification and prediction inference. Even with just a value of an artificial zero, the training process does not converge equally for those inputs without padding.

Multihead Attention significantly improves the time it takes the model to converge during training, using multi-heads. This can be viewed as adding redundancy by adding redundancy in the number of input feature. For multiple encoders, the output of the prior one is fed as the input of the next one. Likewise, Multihead Attention has the same effect to the decoder block. The cross attention with the encoder block output projects the current sequence to the transformed encoder output. Then, the overall output is input to a linear transformation whose output is input to a Softmax transformation for classification inference. The cross attention provides a measure of the closeness between encoder input and the target during training.

This mechanism doesn't provide sufficient inference accuracy for several reasons. The words embedding has too much swing at the input and convergence is attained on regions of low variations. Second of all, the embedding input is not normalized in a small region with range<d in the range [0, 1]. Third, word context typically doesn't have pattern similarities.

The query, key have dim (seq_len, qx) and the value (seq_len, vx), in itransformer qx and vx are the same in both the encoder and decoder.

For the small dataset range the Softmax operation in Attention outputs a matrix (seq_len, qx) with probability values close to each other. The resulting matrix is multiplied by the Values matrix whose output after normalization is fed to a linear operation. The linear operation transforms the input into an output to achieve a weight set representative of the training ensemble. For a time series, it would be approximating the input to the encoder. That is possible for many different datasets because the input is normalized in a small range ˜0.1 for the given domain.

The same applies to the first attention block in the decoder. For cross attention with the context vector from the encoder, attention operates on the one step shift in the future from the decoder input so in most cases the output of the Softmax operation would be similarly uniform across the input features. The next main operations, the linear feed forward network (FFN) and the subsequent linear neural network, would provide the estimated future values in the time series. The last layer provides an estimation transformation for the input sequence in the Encoder. Generally, a weighted linear combination of tensor values representing a floating point sequence can be estimated to any degree of accuracy. Math. Control Signals Systems (1989) 2: −314 (G. Cybenko) provides a proof of this estimation for any sigmoid and a time series.

For classification, a Softmax operation is added at the output to select the most likely class from the log its output in the last linear operation.

To summarize, the encoder block transforms the input batch into a probabilistic estimation which is linearly weighted at the output. This output tensor provides a contextual entropic measure that projects on the output of self-Attention blocks in the Decoder Block. The resulting Tensor is fed to two linearly weighted operations to output a close replica of the future values in the Time Series.

Processing of data is necessary and essential for inference accuracy. Without it, the transformer would not have an advantage over other algorithms such as the CNN and the GAN. The Attention mechanism is a transformation that correlates similarity in number sequences. Its functionality is analogous to the one-layer or multi-layer Deep Neural Network (DNN) or the sigmoid. The sigmoid enhances the inference of a DNN but it does not make it perfect without other functionalities. For data inputs with low variance, averages of different time series that vary a lot, for example from 50 to 0.5, the Attention mechanisms cannot provide perfect classification. Normalization at the same level in a small range in the interval [0, 1], using the Attention mechanism, accomplishes that goal.

The process that allows inference in the autoencoder to any degree of precision is based on the main building blocks. First is the multi-head attention in the encoder which projects two tensors using cosine similarity. The method used for time series is based on the one step predictor in which case the projections nears 1 for both the encoder a decoder. The morphology of the ordered dataset is such that the difference in target and inputs is not large even for a big jump in the future since that change will be included in the next iteration. The filtering properties of the cosine similarity allows the neural networks to converge to high precision with weights for inference of multiple datasets.

The feeding of subsequent batches guarantee the consistency of the same function. Each subsequent input is just shifted by one value. N step prediction can be computed by n inference steps on predicted values. Another method is to build an input with n features shifted by one value to produce predictions of n values in the future when we know a priori what those values are or when we have a good a priori estimate of those values during training. Since we know the target beforehand usually, the first case applies.

Qualitatively, the Transformer Autoencoder can be made to classify perfectly by restricting the range in a small region in the interval [0, 1], for example, maximum difference of 0.3. What matters is the error between input and output. For images, if the datasets are restricted within that range, all images are statistically similar. Weight updates are not significantly large and the right image is recovered by the inverse operation at the output. The Transformer Autoencoder can be treated as a black box. The error distribution has smaller variance in that small range. When data is normalized at different levels, the error distribution from different error time samples may be too large.

The original canonical form is not necessarily optimal. Herein, another model will be described that is more efficient than the original one for perfect inference for n-dimensional datasets other than the NLP ones. First, the most important component is to normalize the input to a small range in [0, 1]. On the encoder side, positional encoding is no longer necessary since for floating point sequences, the relevancy of context or relationship between words is not fully applicable. Other forms of Attention mechanisms can also be used. Similarity based on projection alone is an obvious variant. The output of the FFN after the Attentions heads provides an estimate of the input. This FFN output is fed to the multi-head Attention blocks in the Decoder side. This can be treated as an additional cross correlation to the Decoder input. The Attention output from the Encoder could be fed directly.

This normalization method can also obviate the need for multiple Attention heads. One or two heads may be sufficient to create nearly perfect inference. Another variation to the original approach is to compute Attention heads in parallel with different Linear functions projections and concatenate their output into the FFN or feed it directly to the cross Attention block in the Decoder. The same applies to the Decoder side including the number of heads in the cross Attention and the parallel operation.

On the input side for the Encoder and Decoder, a Time2Vec component can be integrated at the output of the normalizer. This can provide additional redundancy and make it converge better for periodic components in the input sequences.

This can also be applied to the BERT canonical form on the Encoder side. For the BERT, the output layers would be the same as the output layers of the Decoder. Thus, the Linear layer is used for forecasting of future values and the Softmax Layer in conjunction with the Linear layer is used for m-class classification.

Classification can be performed with inference equaling 100%. This singular method is performed by defining a class from a pdf, such as a Gaussian pdf, with given mean and standard deviation which are chosen close to a centroid representing the mean for that class. For example, for. 4 centroid classification problem defined as the corners of a square of length 1, the standard deviation can be chosen so that most of the points are within 0.2 units from a corner.

For the NLP problem with a vocabulary size of n words, a hyper cube would define that data set. During training, each centroid is translated to the center with the given mean and std dev parameters. In general the mean and standard deviation have arbitrary values but the centroid is translated to the center with a given sample spread around the origin. This can also be represented on the Cartesian plane by bands y1=c1 and y2=c2 for all x. Any number of bands can be defined in the Cartesian plane.

Another way of visualizing this for the NLP problem, is to define a word as an integer on the x axis. A band x1=k1 and x2=k2 is defined with an integer inside of it but not overlapping adjacent integers. The range for each integer band is also predefined. During training, each integer is moved to the origin and tagged with that integer. During inference, classification is performed on the trained model and the class is inferred by translating the origin to the corresponding integer defined by the corresponding word. In this case, positional encoding would be required. This method is the only one that can provide 100% accuracy during inference.

A dataset of particular importance in communications systems belongs to a class of modulated signals that carry information over memoryless channels. This can be communications over satellite networks or fiber optics networks. In general, these signals represented by time series can vary greatly over time but essentially are corrupted by a stochastic component, following a Gaussian process. The time series can have jumps that follow a Poisson process.

The general characterization would be a slowly-varying function with an envelope that is Gaussian distributed and jumps whose arrivals can be modeled by a Poisson process.

The processing of data before input to the encoding functions is comprised of mathematical functions such as Euclidian distance, correlation, kernel transformations, smoothing and filtering, hamming distances, and normalization to name a few.

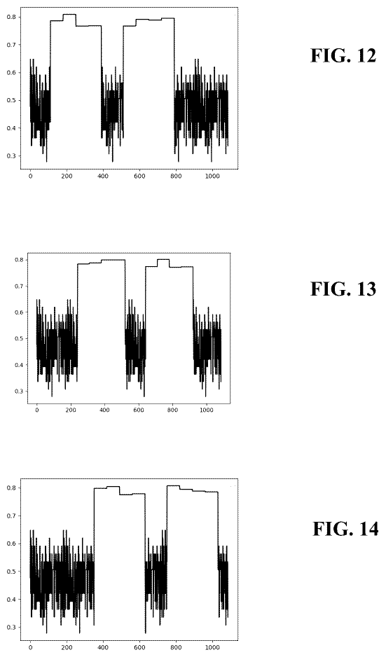

Another important factor is the creation of synthetic datasets whose generation closely approximates the behavior of any data set in question. In addition, the datasets have to be assembled in such a way that the input to the algorithm is consistent in terms of statistics. One could say that the dataset could be represented by samples that are independent identically distributed so that the model training process produces a weight set that can be used for many representations of the input raw data. Synthetic datasets used to detect several types of rises are shown in FIG. 12.

Interestingly enough, if a time series normalized within a specific range is fed directly to the encoder and thus bypassing the word embedding can produce inference that is the same as the input with an error that can be made to converge to any negligible value. This is shown in FIG. 2 which shows a prediction use case with prediction of 8 values in the future and 10 from the past. Keeping the input in the same range would allow the output to converge to the same targets. For the case of a time series, the equivalency to word embedding is a mechanism such as the time vector with periodic components. The input is still normalized within the same range but, in this case, it is stochastic in nature so that that weight formation would not favor any specific sub-range and the input would be a uniform stochastic input. The Time Vector is described in paper Time2Vec: Learning a Vector Representation of Time, Seyed Mehran Kazemi et al.

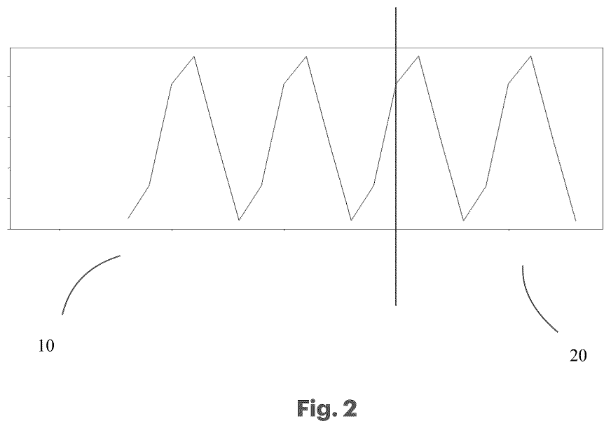

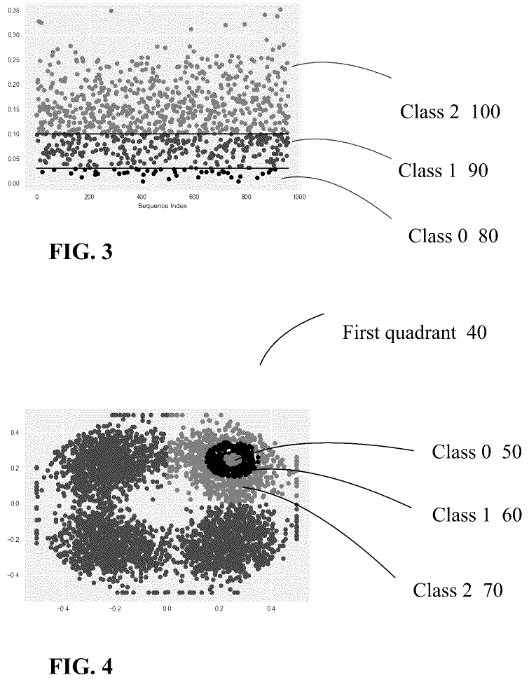

The Figures illustrate several use cases related to what is claimed in this patent. FIG. 3 and FIG. 4 illustrate a cases where points belonging to a centroid can be classified with perfect accuracy. The centroid in the first quadrant 40 has three classification regions 50, 60, 70. FIG. 4 shows the three regions 80, 90, 100 of this centroid where classification has an accuracy of 100%. This method can be used to replace other classical methods such as K-nearest neighbors or K Means. This use case also represents a building block for other classification use cases including the NLP problem which the 2017 paper elaborates in detail. The approach is described later in this specification.

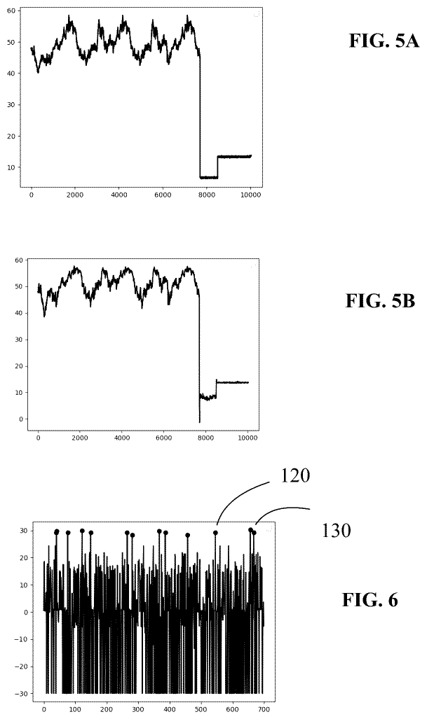

FIG. 5a and FIG. 5b comprise a prediction use case in which the future values in a time series can be predicted faithfully with an MSE lower than 1E0-6 and an a maximum absolute error within 1%. Typical datasets in a satellite communications have a slowly moving average value with a Gaussian envelop. These datasets lend themselves for close predictions with more than 90 steps in the future. Other datasets such as the ones with Wiener process statistics can be transformed similarly to attain similar prediction statistics. These include segmenting certain sections of the time series so that its statistics would produce a hyperparameter configuration to attain faithful inference. The segments then could be reassembled to create the original dataset.

FIG. 6 represents an anomaly detection use case where the time series is segmented and the transformer algorithm detect the anomalies.

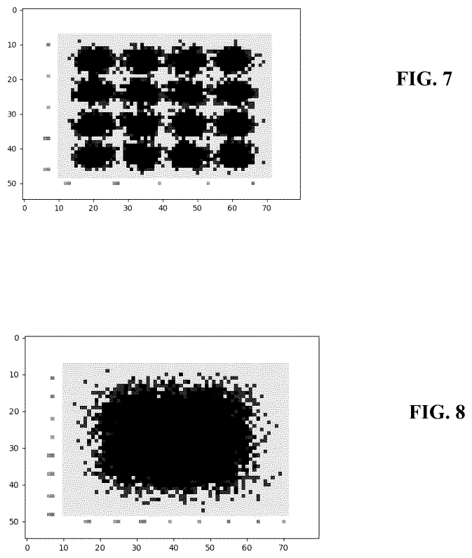

FIG. 7 and FIG. 8 represent a computer vision problem related to centroid performance mapping. FIG. 7 shows 16 centroids representing a modulation scheme called 16 QAM. Ideally, all the points should be close to the centroid but imperfections in communications system may cause the points to overlap themselves to resemble the points in FIG. 8. The algorithm detects all the deviations from the maximum permissible departure from each centroid. Pixels in gray scale can be normalized in a small range in [0, 1].

The other computer vision problem is a generalized image classification problem in which each pixel is normalized the same for each RGB component. Additionally, synthetic datasets can be used in the training stage to attain 100% classification of images.

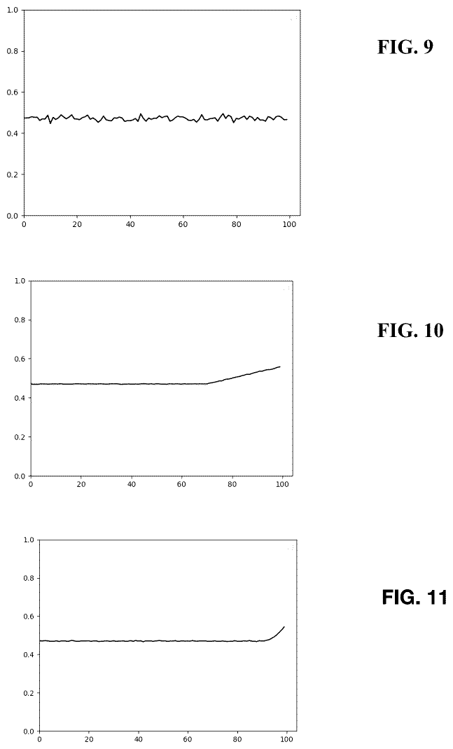

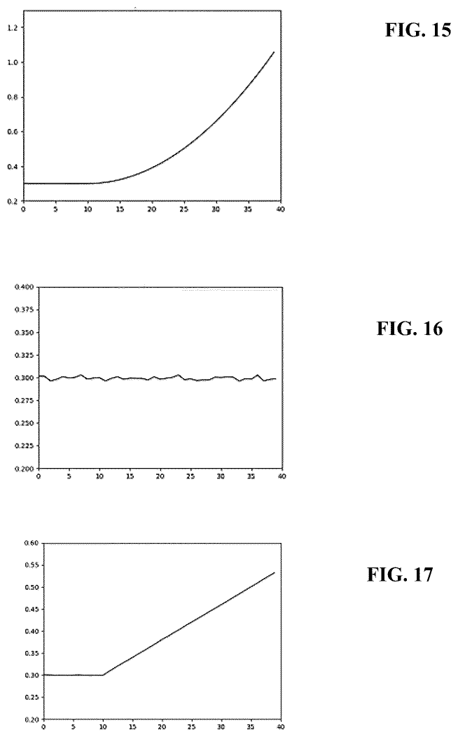

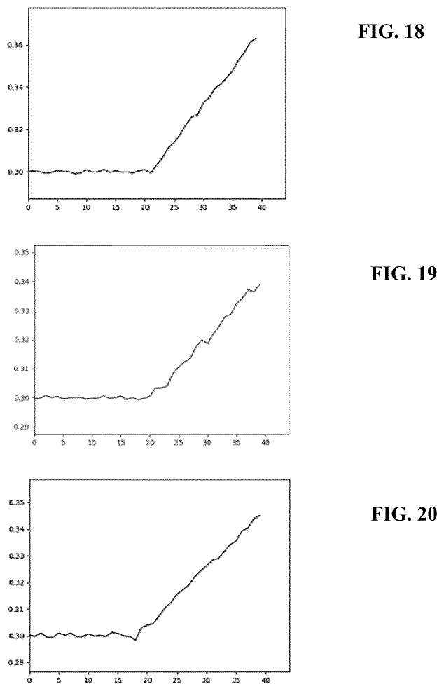

For the pattern recognition problem, the Transformer model can be trained with synthetic functions as shown in FIGS. 9-11 and FIGS. 15-20. For the case of time series, synthetic function can be used to detect straight line segments or rises in the sequence. A specific pattern can be detected from a section in the time series in FIG. 5. That specific section would be a specific class to detect.

Other patterns can be detected such as the pulses with background noise in FIGS. 12-14. The same normalization process is performed in an interval [0, 1].

Without loss of generality, datasets distributed as G(m, stdev) are generated by the receiving functions of the receiver. The processing functions of the receiver may cause jumps in the time series that may vary from 1 unit to 15 units. The jumps arrive as a Poisson process and there may be 1 to 3 such jumps in a series of 3000 values. The jumps themselves are not overly important as the fact that the time series follows in general a Gaussian process. Signals like these can be easily filtered to remove the noisiness and leave a sequence that can be easily manipulated for inference. Filters like the exponential moving average can be used to extract only relevant information.

The mapping of the input time series to the encoder input is performed by the Time Vector algorithm. For a data shapes (n samples, m), the mapping results in shapes of (n samples, m, 2). One component results from the multiplication of the input sequence with a random vector from a uniform distribution. The other component results from the multiplication of the input sequence with a sinusoidal component to emphasize any periodic patterns in the sequence. This can be done for any number of input features (n samples, m, k) to (n samples, m, k+1).

The resulting context vector is input to the decoder and the additional processing of the decoder are the same as those of the NLP model with the exception of the output that could be a Neural Network with s outputs for an MSE estimator or v classes for a classifier.

It is important to note that Time Vector can also be replaced by a another mapping by multiplying each input from k features with c vectors from a uniform distribution to produce (n sample, m, c). Performance can improve for c>3 but not much more for c>5.

Other LLM modifications based on the Transformer Autoencoder described herein to produce perfect inference as the method to convert each integer at the output of the embedding layer into a set of random floating points centered around the embedding integer. The range of this set is m+/−Y and the domain is m+/−X where m is the integer and Y and X are small values in the interval (0, 0.5). m can be shifted to the origin for each integer embedding.

For general datasets, a function in [symbol] or [symbol] can be synthesized as described above by partitioning datasets in segments and/or creating periodic functions of these. For example, a Wiener process can be synthesized to have cyclostationarity properties. For images, synthetic datasets can be created for each image class. Similar normalization processes are implemented when the datasets sets are segmented accordingly.

### Synthetic Functions

The general form for 1-dim sequences is;

$$f ( x ) = {\sum }_{i = 1}^{n} {f}_{i} ( x ) ; \qquad ( 7 )$$

where the domain of each function is contiguous. For example;

$$f 1 ( x ) = k 1 + n ( x ) ; \qquad ( 8 )$$

where k1 is a constant, n1 is G(m1, sig1) for x=[0, a1), m=k1, and xn is the last value in seq_len;

$$f 2 ( x ) = ( x - a 1 ) \hat{} 2 + n 2 ( x - a 1 ) + k 1 ; \qquad ( 9 )$$

where n2 is G(0, sig2) or n2=0, for x=[a1, a2], where a2 is segment length and;

$$f ( x ) = f 1 ( x ) + f 2 ( x ) . \qquad ( 10 )$$

This form can also be used for pattern recognition to classify rises in the time series. Also, any of the function can represent a specific segment of the time series. This segment can be processed such as synthesizing the average value or smoothing that segment so that the training process can converge on that segment as a specific class. The raw segment can also be used by itself of as part of f(x) in the dataset as the specific class.

The same can be applied to datasets with dimensions greater than 1. For example, when training images, smoothed prototypes of the classes can be used during training. Airplanes, cars, trains, for example, can be represented with basic geometric shapes without including low details.

An example that was used during training is the dataset of numbers [0, 1, 2, . . . , 9]. The gray scale images were normalized in a range in the interval [0, 1]. Thus, the gray scale values of 0 to 255 were compressed in that range and a set of the images were trained which provided 100% classification inference.

As mentioned previously, the method specified herein is agnostic to the input dataset. The dataset can be n-dimensional tensors with floating point values with any number of features. Depending on the specific use case, the data has to be processed for that particular use case. The simple example of image classification, can be processed as an array (64, 64) or 64 rows and 64 features. That frame is normalized as described above and input to the trained model for inference to any of the m classes.

For the case of pattern recognition of a segment in a time series, the array is (1, seq_len) which is partitioned into (c, seq_len/c) where c is an integer and seq_len is mod c. The resulting array is normalized as described above and segments are input in batches to find the desired pattern. This can be a 2 class classification use case, class 0 would be the desired pattern and class 1 would be a true negative.

There are many problems in optical communications that require that type of inference. One of interest is finding the pattern of the filter in a laser receiver. The filter can take into anomalous shapes that would render the fiber optics network inoperative. An extreme tilt in the filter passband would shut off the network because too many errors would be produced at the output of the receiver.

The stochastic pulses in the CPU resources usage can be generated from;

$$f ( x ) = {\sum }_{i = 1}^{n} {f}_{i} ( x - {a}_{i} ) ; \qquad ( 11 )$$

$${⋃}_{k = 1}^{n} ( {x}_{k 1} , {x}_{k 2} ) ; \qquad ( 12 )$$

for k=0, the Interval on x is closed on the left, and for k=n the interval is closed on the right;

$$f 1 ( x - a 1 ) = k 1 + n ( x - a 1 ) ; \qquad ( 13 )$$

$$for x in [ x 1 i 1 , x 1 i 2 ) ;$$

$$fj ( x - aj ) = kj + n ( x - aj ) ; \qquad ( 14 )$$

$$for x in [ xji 1 , xji 2 ) ;$$

$$aj = xj - 1 , i 2 ; \qquad ( 15 )$$

$$aj + 1 = xji 2. \qquad ( 16 )$$

f is composed of mini segments fn to form a single pulse. The other pulse g(x) can be similarly defined. They are defined as sums below;

$$g ( x ) = {\sum }_{i = 1}^{m} {g}_{i} ( x - {a}_{i} ) ; \qquad ( 17 )$$

$${⋃}_{k = 1}^{m} ( {x}_{k 1} , {x}_{k 2} ) ; \qquad ( 18 )$$

for k=0, the interval on x is closed on the left, and for k=m the interval is closed on the right;
the domain of f(x) is [xli1, xni2];
the domain of g(x) is [xji1, xmi2];

$$x 1 i 1 = C ; \qquad ( 19 )$$

C is a random variable from the uniform distribution in the interval (c10, c11);

$$min ( C ) = c 10 ; \qquad ( 20 )$$

$$x 1 j 1 = K ; \qquad ( 21 )$$

K is a random variable from the uniform distribution in the interval (k10, k11);

$$min ( K ) = k 10. \qquad ( 23 )$$

The following sums represent two square pulses with noise in between;

$$f ( x ) + g ( x ) + n ( x - bh ) ; \qquad ( 24 )$$

where;

$$h = 1 , 2 , or 3 ; \qquad ( 25 )$$

the Domain of n is [0, xli], [xni2, xji1] or [xmi2, k];
thus, it exists in the regions where f(x) and g(x) are not defined;
the interval [0, k] represents the sequence indices, e.g., [0, 1000];
a small noise component can also be added to the top of each pulse definition, f(x) or g(x).

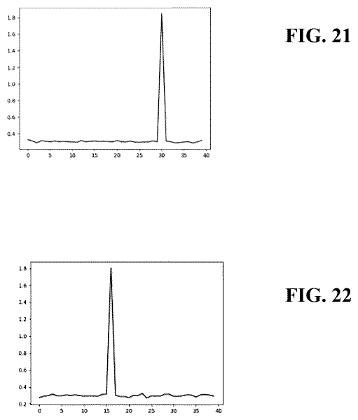

For anomaly detection problems, a single pulse of one or two values for example can be to move stochastically in a given domain as shown in FIGS. 21-22. The domain could be a sequence of 20 samples with a spike normalize in a small range within the range (0, 1). This model can represent any type of spike if the sequence length is small enough. Of course any number of spikes can be used during training but 1 spike could be just as effective as 2 or 3 spikes if the number of samples is small.

The proof of exact inference follows the tenets below. The Softmax operation on the query and key produces a probability values that are nearly the same since the standard deviation is small for Q and K. This uniformity matrix multiplies the Values yielding an output that is weighted by values that are close to each other. Thus the FFN produces a dim-d model estimate of the Multihead output.

For multiple Encoders the computational totality would be similar The resulting tensor is Cross Attention with the Decoder Multihead whose output has the same properties as that of the Encoder. The dim-d model Cross Attention has similarity close to 1. Therefore, the output of the Decoder FFN would be an estimate of the Cross Attention output. The output of the Linear Weighted mapping is then an estimate of the Decoder input sequence future values. This linear layer would be decompressing to the Decoder input dimensionality. Thus, the following condition sets the error bound;

$$\vert F ( x 1 , x 2 ) - G ( x 1 , x 2 ) \vert < ε ; \qquad ( 26 )$$

the error can be arbitrarily small since the estimate G (of the kernel or the convex loss function to be optimized) is guaranteed to be close to the Decoder input since the similarity in each Attention operation is close to 1. In addition, the estimate is performed by a FNN which rigorously converges to any function under these conditions.

In general any Attention output S would have the form;

```
S = [p11 , p12, ... , p1m;
      p21, p22, ... , p2m;
          ...;
        pn1, pn2, ..., pnm] (28);
where for every row;
pij ≅ pkh (29);
where;
    pij ≅ P/m (30);
    and;
  P = 1 (31);
thus;
A = Matmul(S, V) (32);
```

is approximately a weighted version of V with weights having values close to each other.

For classification, the Softmax in the output layer of the Transformer would provide the most likely probability for the class. Another normalization layer can be the output of the linear layer.

For prediction of future values, the reconstructed sequence is de-normalized with the same parameters to reproduce a sequence in the same scale as the original one.

A two layer neural network with the mapping;

$$F : X 1 \times X 2 -> R ; \qquad ( 33 )$$

can approximate a kernel G (of the estimate of K(x1,x2)) as described in several papers including, Cybenko, “Approximation by superpositions of a sigmoidal function. Mathematics of Control, Signals and Systems”, Funahashi, “On the approximate realization of continuous mappings by neural networks” (January 1989), and Hornik, et al, “Multilayer feedforward networks are universal approximators” (January 1989).

G represents the Kernel, comprised of the Dot Product operations on the Attention mechanism and other mappings, that is approximated by the 2 layer FFN at the output of the Transformer decoder. The same can be said of other variations of the Transformer such as the BERT.

An exact solution also exists on the Transformer optimization problem for a stochastic descent on a convex function with any general loss function. This is described in the literature by papers: Kimeldorf, et al, “Some results on Tchebycheffian spline functions” (January 1971), Scholkopf, et al, “Learning with Kernels: Support Vector Machines, Regularization, Optimization, and Beyond” (2002), and, Argyriou, et al, “When Is There a Representer Theorem? Vector Versus Matrix Regularizers” (November 2009).

A summary of these approaches is described in Wright, et al, “Transformers are Deep Infinite Dimensional Non-Mercer Binary Kernel Machines” (Jun. 2, 2021).

When the Transformer input is normalized as described above in a small range in the interval [0, 1], the iterative computation during training as controlled by the stochastic descent process to find an ideal weight distribution results in operations whose output does not vary markedly by an MSE measure from the input. Therefore, the training process converges very fast in MSE measure to a replica of the input sequence.

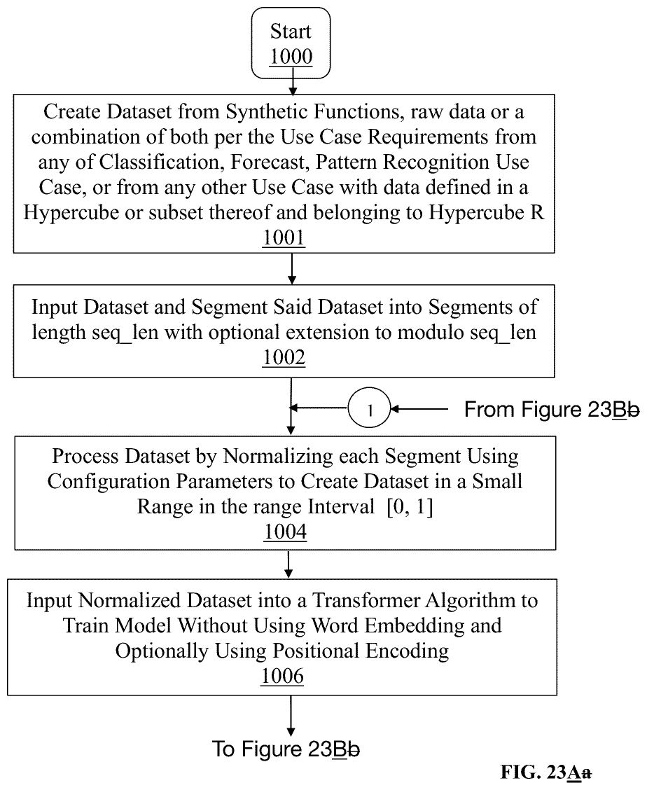

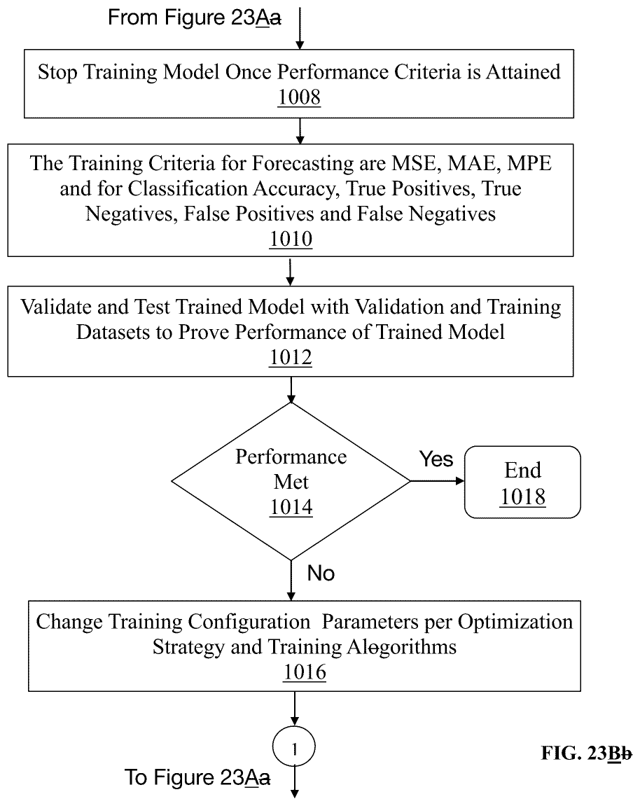

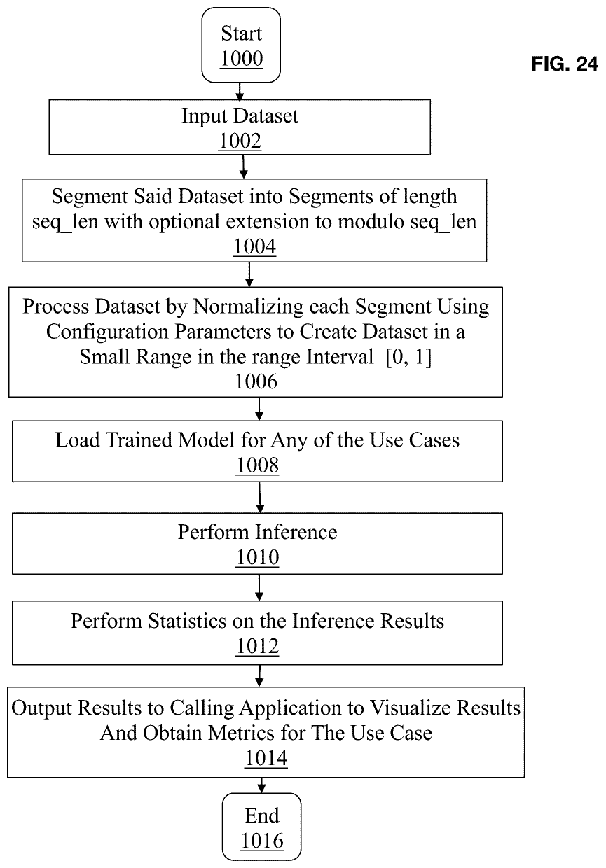

The method to train a model from a n dimensional dataset is shown in FIG. 23A and FIG. 23B. The dataset is created from synthetic functions, the raw dataset or a combination of both 1001. Depending on the use case, the synthetic functions can be constructed as described above. The synthetic functions can form the whole training dataset except for specific variations that could be necessary from the raw dataset. The created dataset is input 1002. Then, the dataset is segmented in segments of seq_len values with shape (n, seg_len) 1004 where the dataset is optionally extended at the oldest value with values with similar statistics so that the length of the time series or sequence is modulo seq_len. The segmented dataset is normalized with predefined parameters 1006 so that the absolute deviation varies in a small range. The normalized dataset is optionally processed by a Time2Vec component or by a multiplicative random and Gaussian component to process each segment. The resulting operation creates a number of randomized number of tensors (or Tensor) of seq_len ordered as features for each dataset segment. Training is initiated 1008 with a loss function criteria where the convex problem approximates the target dataset with any degree of accuracy. Optimization of the training process is achieved by selecting an efficient algorithm to attain the absolute minimum location of the convex problem. These include stochastic descent of several types such as a regular random descent or an Adam descent, etc. Training is stopped when that condition is achieved 1010. The model performance is tested by constructing validation and test datasets 1012. If the model is satisfactory training is stopped and the model saved 1016. Otherwise, the configuration parameters and another training run is executed 1014.

The processed dataset is input to a Transformer algorithm (Autoencoder, BERT, Informer, etc.) where it is trained to specified inference performance with a predefined set of configuration parameters. The criteria to stop the training process can be the Minimum Squared Error (MSE) for metrics of inference values such as forecast of future or accuracy for classification cases.

The training optimization for the Transformer convex problem is a predefined loss function where the minimization criterium is achieved by a stochastic descent, for example.

For classification, the criteria to use is accuracy wherein the logits are input to an inference rule such as the Softmax function to select the most probable class. For forecast inference, the predicted sequence set is decompressed to create a replica in the range of the original input dataset.

For centroid classification problems, synthetic datasets for each centroid are used to train the Transformer algorithm. The dataset is drawn from a pdf such as a Gaussian pdf with (0, stddev). Thus, a centroid in location (x1, x2, . . . , xn) is translated to the origin for each training instance and for each class.

For pattern recognition problems where each pattern is an m dim dataset, eg, (1, m) taken from a time series, for example, synthetic functions are created for each pattern. Each sequence is treated as the forecast inference case but each pattern comprises a class and thus a Softmax classifier would be used to provide the inference for each class of interest.

The method to compute inference from a n dimensional dataset is shown in FIG. 24. The dataset is input 1002 to the trained Transformer model. Then, the dataset is segmented in segments of seq_len values with shape (n, seg_len) 1004 where the dataset is optionally extended at the oldest value with values with similar statistics so that the length of the time series or sequence is modulo seq_len. The segmented dataset is normalized with predefined parameters 1006 so that the absolute deviation varies in a small range. The normalized dataset is optionally processed by a Time2Vec component or by a multiplicative random and Gaussian component to process each segment. The resulting operation creates a number of randomized number of tensors (or Tensor) of seq_len ordered as features for each dataset segment. The model is loaded 1008 and Inference is initiated 1010. The inference results are post processed to convert the output to its original range values and/or to perform statistics test goodness or to compare to other datasets or to determine the class for the input, depending on the use case 1012. The results are output to an application and are visualized and characterized by relevant statistics 1014.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

1. An algorithmic inference mechanism is comprised of a computational algorithm mathematical structure embodied in a computer program, the computer program code comprising computer executable instructions hosted in a non-transitory computer-usable medium wherein the algorithm is comprised of an Attention mechanism residing in an Autoencoder structure denominated Transformer Autoencoder; wherein said Attention mechanism and Autoencoder structure can produce inference to any degree of accuracy or faithfulness from a (n1, n2, n3, . . . nm) dataset input; wherein the Attention mechanism and Autoencoder structure is further comprised of a data processing block at the input of the encoder comprised of a segmentation block, normalization block, filtering block, and feature build block consisting of mathematical functions including Euclidian distance, correlation, kernel transformations, smoothing and filtering, hamming distances, and normalization; wherein the normalization block processes raw or segmented data in a small range within the interval [0,1]; wherein the inference algorithm can operate in a number of mathematical inference operations, including forecasting of future values, classification, pattern recognition, and anomaly detection; wherein an embodiment of the forecasting of future values inference case includes segmenting the time series into n-value segments, smoothing each segment by filtering, normalizing each segment in a small range in the interval [0, 1], and forecasting one or more values in the future by iteratively forecasting from each previous inference value or by forecasting one or more values simultaneously; wherein a first embodiment of the pattern recognition inference case includes creating synthetic functions for M patterns extracted from a time series, where each pattern is a n-value segment; normalizing each segment in said first embodiment of the M-class pattern classification problem in a small range in the interval [0, 1], and classifying each pattern in said first embodiment of the M-class pattern classification problem by M-class classification inference; wherein the synthetic functions in said first embodiment of the M-class pattern classification problem consist of functions belonging to the set or Real or Complex numbers; wherein each synthetic function in said first embodiment of the M-class pattern classification problem is formed by one or more than one contiguous functions in a specified domain; wherein each function in said first embodiment of the M-class pattern classification problem can also be synthesized from a stochastic process; wherein a first embodiment of the classification inference case includes training of the algorithm using synthetic data from a probability distribution function centered around one centroid, representing a class, in a multi-centroid classification case; wherein a second embodiment of the classification inference includes the classification of images from a (n, m) dataset wherein each image is normalized in a small range in the interval [0, 1] and wherein each image belongs to one class in a M-class classification inference case; wherein a second embodiment of the pattern recognition inference case includes extracting the M patterns from a time series wherein each pattern is a n-value segment, smoothing each segment by filtering, normalizing each segment in a small range in the interval [0, 1], and classifying each pattern in a M-class classification inference case; wherein the anomaly detection inference case includes creating synthetic functions; wherein each function is a n-value segment consisting k values whose number is much less that the n-value segment, normalizing each segment in a small range in the interval [0, 1], and classifying each anomaly pattern in a M-class classification inference case; wherein the synthetic functions in said of the M-class anomaly detection problem consists of functions belonging to the set or Real or Complex numbers; wherein each synthetic in said of the M-class anomaly detection is formed by one or more than one contiguous functions in a specified domain; wherein each function in said of the M-class anomaly detection can also be synthesized from a stochastic process; wherein said Transformer Autoencoder can be replaced by any variant such as a Transformer Encoder, including the Bidirectional Encoder Representations from Transformers, and Transformer Decoder algorithms.

2. A method for algorithmic inference training comprised of a computational mathematical structure embodied in a computer program, the computer program code comprising computer executable instructions hosted in a non-transitory computer-usable medium wherein the algorithm is comprised of an Attention mechanism residing in an Autoencoder structure denominated Transformer Autoencoder wherein said Attention mechanism and Autoencoder structure can produce inference to any degree of accuracy or faithfulness from a (n1, n2, n3, . . . nm) dataset input wherein the Attention mechanism and Autoencoder structure is further comprised of a data processing block at the input of the encoder comprised of a segmentation block, normalization block, filtering block, and feature build block consisting of mathematical functions including Euclidian distance, correlation, kernel transformations, smoothing and filtering, hamming distances, and normalization wherein the normalization block processes raw or segmented data in a small range within the interval [0,1], comprising the steps of:
Creating the dataset from raw data or synthetic functions, or both;
inputting the created dataset to the Transformer input block;
segmenting the dataset into segments of m-values with shape (n, m) wherein the dataset is optionally extended at the oldest value with values with similar statistics so that the length of the time series or sequence is modulo m;
normalizing the dataset with predefined parameters so that the absolute deviation varies in a small range wherein the normalized dataset is optionally processed by a Time2Vec component or by a multiplicative random and Gaussian component to process each segment wherein the resulting operation creates a number of randomized number of tensors (or tensor) of m-values ordered as features for each dataset segment;
training the dataset with a loss function criteria wherein the convex problem approximates the target dataset with any degree of accuracy wherein the optimization of the training process is achieved by selecting an efficient algorithm to attain the absolute minimum location of the convex problem wherein the efficient algorithm includes stochastic descent of several types such as a regular random descent or an Adam descent;
stopping the training process when the optimization criteria is attained;
testing the performance of the trained model by constructing validation and test datasets;
wherein, if the model performance is satisfactory, training is stopped and the model is saved;
wherein, if the trained model performance is unsatisfactory, the configuration parameters are modified, using a configuration parameter selection algorithm, and additional training runs are executed until the trained model meets performance criteria.

3. A method for algorithmic inference computation comprised of a computational mathematical structure embodied in a computer program, the computer program code comprising computer executable instructions hosted in a non-transitory computer-usable medium; wherein the algorithm is comprised of an Attention mechanism residing in an Autoencoder structure denominated Transformer Autoencoder wherein said Attention mechanism and Autoencoder structure can produce inference to any degree of accuracy or faithfulness from a (n1, n2, n3, . . . nm) dataset input; wherein the Attention mechanism and Autoencoder structure is further comprised of a data processing block at the input of the encoder comprised of a segmentation block, normalization block, filtering block, and feature build block consisting of mathematical functions including Euclidian distance, correlation, kernel transformations, smoothing and filtering, hamming distances, and normalization; wherein the normalization block processes raw or segmented data in a small range within the interval [0, 1], comprising the steps of:
Inputting the dataset to the Transformer input block;
segmenting the dataset into segments of m-values with shape (n, m) wherein the dataset is optionally extended at the oldest value with values with similar statistics so that the length of the time series or sequence is modulo m;
normalizing the dataset with predefined parameters so that the absolute deviation varies in a small range wherein the normalized dataset is optionally processed by a Time2Vec component or by a multiplicative random and Gaussian component to process each segment wherein the resulting operation creates a number of randomized number of tensors (or tensor) of m-values ordered as features for each dataset segment;
smoothing the dataset, using a smoothing filter;
loading the trained algorithmic model;
performing inference, including forecasting of future values, classification, pattern recognition, and anomaly detection;
post processing the inference results to convert the output to its original range values and/or to perform statistics test goodness or to compare to other datasets or to determine the class for the input, depending on the inference case;
outputting the results to an application and visualizing and characterizing the inference results by relevant statistics metrics.
